(19) United States
(12) Patent Application Publication
(10) Pub. No.: US 2017/0089402 A1
(43) Pub. Date: Mar. 30, 2017

(54) CONTROLLED COOLING OF A FRICTIONAL ENGAGEMENT DEVICE IN AN ENERGY RECOVERY SYSTEM

(71) Applicant: Flybrid Automotive Limited, Lancashire (GB)

(72) Inventors: Andrew DEAKIN, Oxfordshire (GB); Daniel JONES, Buckinghamshire (GB)

(21) Appl. No.: 15/310,999

(22) PCT Filed: May 14, 2015
(86) PCT No.: PCT/GB2015/051435

§ 371 Date: Nov. 14, 2016

(30) Foreign Application Priority Data
May 16, 2014 (GB) 1408768.8
Jun. 24, 2014 (GB) 1411222.1
Feb. 11, 2015 (GB) 1502243.7

(51) Int. Cl. F16D 13/72; F16F 15/30; F16D 48/02; F16D 25/12; F16D 48/06; F16D 25/0638

(52) U.S. Cl. CPC F16D 13/72; F16D 48/06; F16D 25/0638; F16D 25/14; F16D 25/123; F16F 15/30; F16D 2500/10412; F16D 2500/1045; F16D 2500/30406; F16D 2500/30412; F16D 13/52

(57) ABSTRACT

An energy recovery system having an energy source/sink and an energy storage system is disclosed. The energy recovery system includes a frictional engagement device adapted for the transmission of energy between an energy source/sink and the energy storage system, a cooling fluid supply for the frictional engagement device, an element for controlling the power flow through the frictional engagement device, an element for varying the flow of cooling fluid from the fluid supply to the frictional engagement device whereby the flow of fluid to the frictional engagement device is made to increase when the magnitude of power through the frictional engagement device is made to increase.

This invention relates to apparatus and methods for cooling a friction engagement device that transmits energy in a vehicle transmission to and/or from the energy storage medium of an energy recovery system.

Power may be transmitted to or from the storage medium in an energy recovery system using a mechanical powertrain. Such systems typically need to continuously vary a speed ratio between the source or sink of the energy and the storage medium in order to accommodate the continuously varying energy storage state of charge (for example the speed of a flywheel) relative to the continuously changing energy source/sink state of charge (for example the speed of a vehicle).

The source/sink of energy may be a vehicle, a moving part of a vehicle (such as a cab on an excavator) or another working part of a machine such as the boom of a vehicle or a crane (in which case the energy to be recovered may be potential energy). The storage medium may be a flywheel, in which case the mechanical powertrain may be coupled directly to the flywheel via a series of ratios and/or a continuously variable transmission (CVT), or it may be an accumulator in which case the mechanical powertrain is used in combination with a hydraulic pump or motor for the transmission of fluid to the accumulator.

In such applications, the mechanical powertrain may include a clutch adapted for power transfer between the energy source/sink and the energy storage medium. The clutch may be used as a part of a group of clutches adapted for energy transfer, to provide a wider variation in speed ratio between elements of the mechanical powertrain than one clutch alone. The clutch or clutches may be used in combination with a CVT such as a hydrostatic pump or pump-motor, or a mechanical variator such as a belt, chain or traction drive. Such devices may provide a suitable range of operating ratios for energy recovery over a suitably wide range of vehicle and storage states of charge. In such applications a clutch may be slipped only during select periods of operation, for example when the variator is at its limit of operating ratio; in such instances, the clutch may be slipped in order to transfer energy when a variator is unable to effect the energy transfer by sweeping its own speed ratio.

Maximising the opportunity for energy transfer in energy recovery systems, for example by offering adequate ratio spread in the mechanical powertrain, improves the benefits that such systems in applications in which energy that may be recoverable is normally wasted, for example when kinetic energy is dissipated as heat in the braking system of a vehicle as it decelerates. It is also important, however, to minimise parasitic losses in the energy recovery powertrain as this erodes the benefits which can be achieved. Such losses can arise from torque dependent losses such as gear mesh inefficiency, from service elements such as hydraulic pumps that supply fluid for control and lubrication purposes, or from churning and drag that typically arise due to viscous effects and that vary with speed.

Some storage systems include elements that run at high speed in order that torques may be minimised for a given energy transfer rate (that is, power). For example in such a transmission using clutches, the size of the clutches may be minimised by running at high speed. In some systems such as kinetic energy storage systems that include a flywheel, the speed associated with the storage device may be maximised in order that mass of the flywheel may be kept to a minimum (because kinetic energy storage=½J·w2, where w is the speed of the flywheel and J is the flywheel rotational inertia). However, running at high speed can result in increased losses and therefore erosion of the energy saving benefits of the energy recovery system. This may typically manifest itself as reduced fuel economy on a vehicle fitted with such an energy recovery system.

Some energy recovery systems use multiple clutches to enable multiple selectable ratios as this enables a wide ratio spread of the energy storage and recovery system, thus increasing the opportunity for storing or recovering energy. Multiple selectable ratios may also increase the efficiency of the energy recovery system by enabling reduced slippage of each clutch when it is transmitting power. Such systems may have 2, 3, or even 5 or 6 clutches.

In a first aspect of the invention, there is provided an energy recovery transmission having a friction engagement device such as a clutch, further including a cooling fluid input arranged to supply cooling fluid to the friction engagement device, the transmission further including a cooling flow controller that controls the flow to the friction engagement device.

The cooling flow controller may be arranged to generally increase cooling flow with the state of engagement of the friction engagement device such as increased flow with increased transmitted torque and/or speed differential across the device and/or dissipated power of the friction engagement device during a slip event.

In this way, the cooling flow will generally match increased heat generation and the additional cooling fluid volume flow rate resulting from increased flow, helps remove this additional heat.

The cooling flow controller may be operable to produce different cooling flow rates over a continuous range between a high flow and a relatively lower flow or may be operable to produce two discrete cooling flow rates at a high flow and a relatively lower flow, including zero flow.

The cooling flow controller is preferably arranged to cause a non-zero flow of cooling fluid including when substantially zero torque is transmitted through the friction engagement device, substantially zero differential speed occurs across the friction engagement device during a slip event or substantially zero power is dissipated in the friction engagement device. This then allows for continuous background cooling of the friction engagement device.

The cooling flow controller may be arranged to cause cooling flow to cease when, or as the friction engagement device is disengaged. This may be used as an alternative or in addition to it being responsive to torque transmitted through the friction engagement device

The cooling flow controller may be arranged to maintain the flow of cooling fluid at a predetermined level for a predetermined time period after a slip event of the friction engagement device. (In this context, a “slip event” may be defined as a period of slipping engagement with parts of the friction engagement device either side of a friction surface of the device, moving at different speeds, during torque transfer). This takes account of the heat capacity of the friction engagement device which will tend to store heat even after it ceases being generated. In this way heat stored in the friction engagement device can be removed so that it is ready for its next operating cycle. In this way the maximum flow required of the cooling system is reduced. Reducing the cooling flow to zero when cooling is no longer required reduces drag when the friction engagement device is not transmitting power.

Preferably, the transmission includes an electronic programmable transmission controller operable to act directly on the cooling flow controller and also to directly control the actuation of the friction engagement device, the transmission controller being arranged to generate control signals which generally increase cooling flow with increased torque transmission and/or slip speed and/or dissipated power of the friction engagement device. Alternatively, the friction engagement device may be actuated by a hydraulic pressure which may typically be generated by a pressure control valve and the cooling flow controller may be a pilot operated valve that receives a hydraulic signal from the pressure control valve output or from the hydraulic pressure in a feed to the friction engagement device actuator, and whose flow area is changed as a function of the pressure signal. As a further alternative, the friction engagement device may be actuated by a hydraulic pressure which may typically be generated by a pressure control valve and the cooling flow may be derived directly from the friction engagement device actuator pressure or from the hydraulic pressure in a feed to the friction engagement device actuator. As a yet further alternative, the friction engagement device may be actuated by a piston in a bore and the bore may include a port which is aligned with a cooling flow port in the piston at a predetermined position in the piston stroke, such that in this position, cooling fluid is communicated through the cooling flow port in the piston to be directed to cool the friction engagement device, whereby cooling is controlled by the actuator piston stroke position.

The friction engagement device is typically a device selectively able to transmit torque and which during operation generates heat. More preferably, it is able to transmit varying amounts of torque. Examples are a clutch, or a plurality of clutches.

In another aspect, the invention provides a method of modulating cooling in a friction engagement device for a vehicle, (for transmitting torque between an energy storage device and a drivetrain of the vehicle), comprising the steps of providing a flow of fluid past the frictional engagement device such that heat is transferred from the frictional engagement device to the fluid, providing means for removing heat from the cooling fluid, and modulating the flow of cooling fluid dependent on the torque transmitted and/or power dissipated by the frictional engagement device or dependent on the state of engagement of the friction engagement device. The torque transmitted by a clutch is typically indicated by the clamp load of the clutch. The requested cooling flow may therefore be modulated in accordance with the requested clamp load on the clutch.

The method may include providing an actuator to engage, disengage and/or allow slipping operation of the frictional engagement device, and modulating the flow of cooling fluid dependent on the clamp force applied to the frictional engagement device. The actuator providing the clamp force may be a hydro-mechanical actuator or may be an electric actuator such as a stepper motor or motor and lead screw.

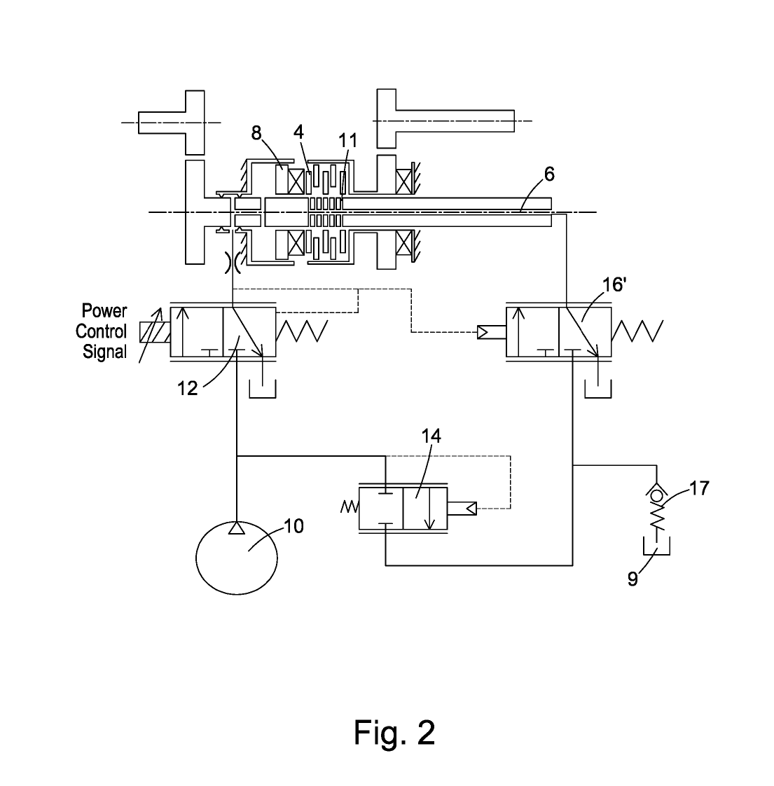

One cooling control arrangement may control the cooling to a set (that is, several or all) of the friction engagement devices in the energy recovery transmission. In such configurations, the cooling flow to all devices of the set may be controlled or modulated simultaneously, the input signal to the cooling controller being determined by the state of the friction engagement device of the set that is transmitting the most torque or dissipating the most power. In the embodiment in which clutch actuation pressure indicates the torque transmitted or power dissipated by a clutch, then all such pressures of the set of clutches may be fed to an array of shuttle valves such that the maximum actuation pressure of the set controls a pilot valve that controls cooling flow to the set of clutches (a modification, for example, of the embodiment shown in FIG. 2). When a cooling pump is arranged to rotate with such a set of clutches, the cooling control signal may be the rotation or coupling of the set of clutches with a drive (for example a flywheel or vehicle driveline). In this embodiment, rotation of the set of clutches causes the cooling pump to rotate which in turn causes cooling flow to be distributed to one or all clutches of the set.

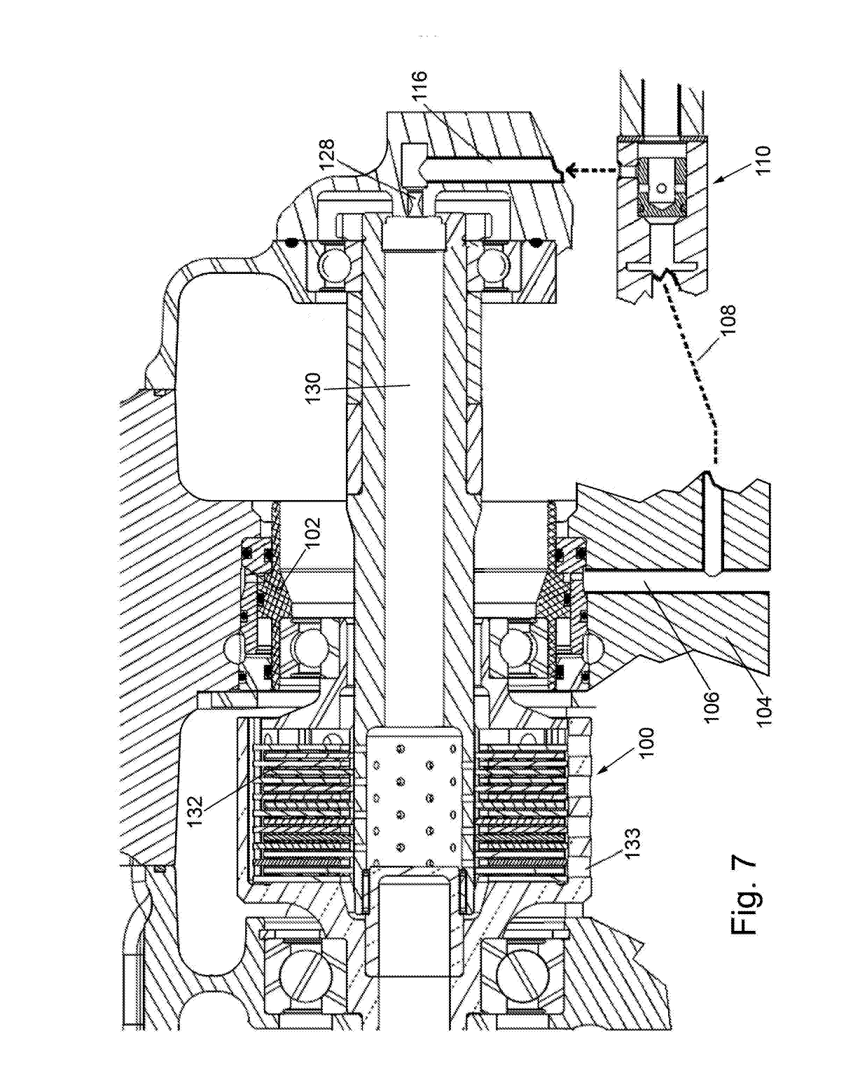

Engagement or energisation of a first friction engagement device may cause cooling flow to be fed or increased, to one or more other friction engagement devices, whether or not they are transmitting torque (for example, a friction engagement device in series, possibly adjacent to the set containing the first friction engagement device). In this arrangement, the pressure applied to the first friction engagement device may control the cooling flow to the one or more other friction engagement devices, for example, by pilot valve means as described in FIG. 2 or FIG. 7.

Embodiments of the invention will be described, by way of example, with reference to the drawings in which:

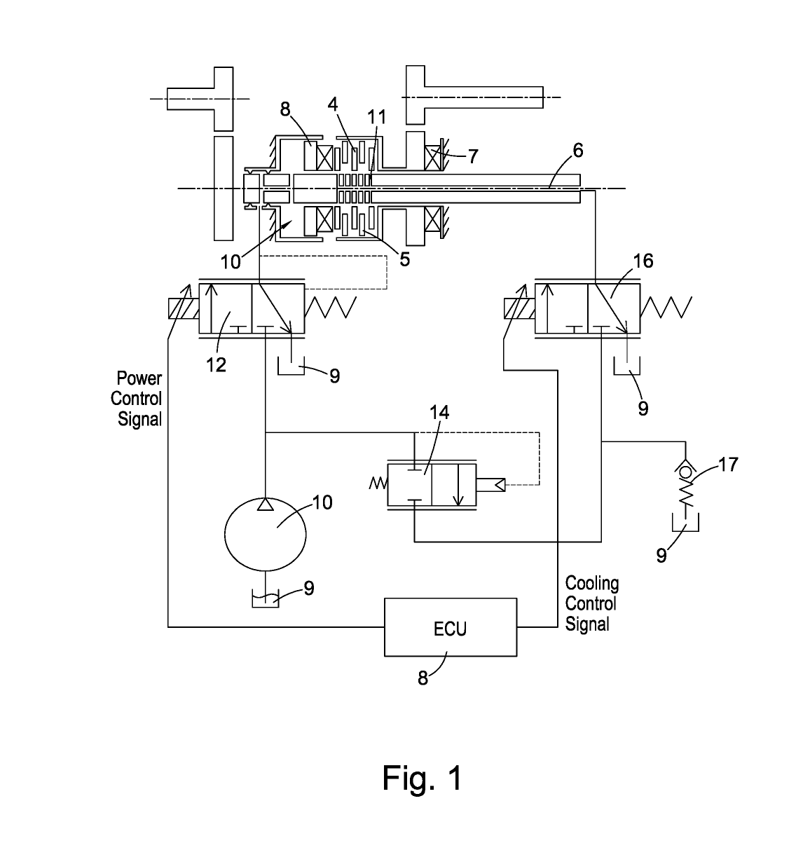

FIG. 1 is a schematic diagram of a cooling system controlled by an ECU;

FIG. 2 is a schematic diagram of a cooling system having cooling flow control by power control means;

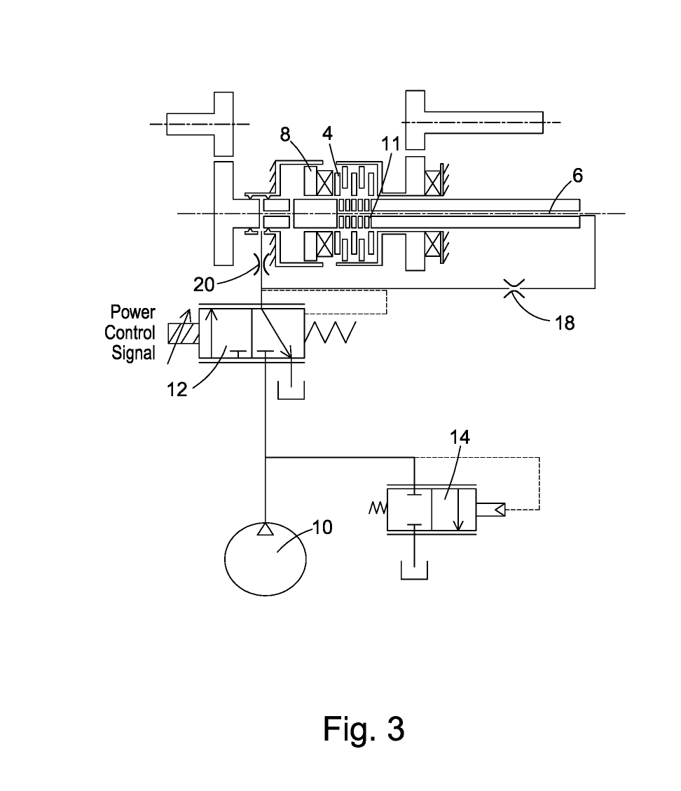

FIG. 3 is a schematic diagram of a cooling system having a direct connection between a power control feed and a cooling feed;

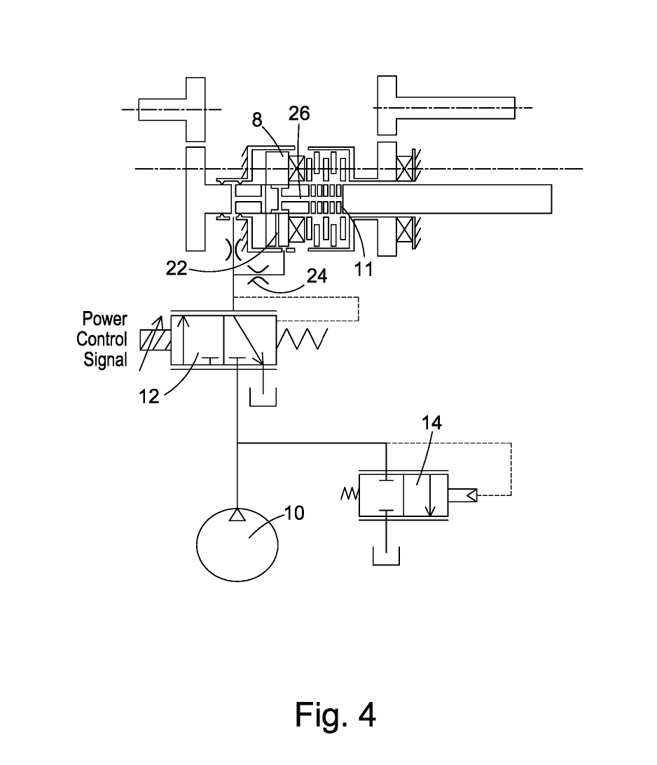

FIG. 4 is a schematic diagram of a cooling system having a control actuator feed which connects with a cooling feed as a power control actuator is moved to different stroke positions;

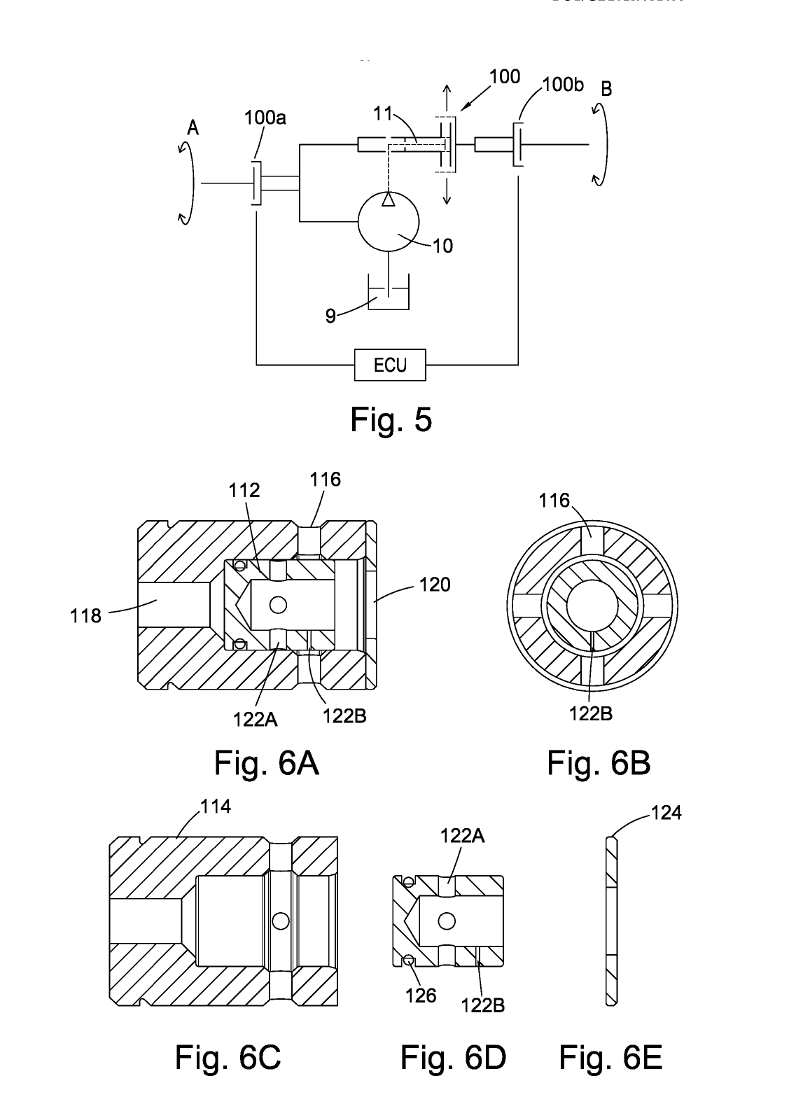

FIG. 5 is a schematic diagram of a cooling system having a coolant pump driven at the same time as one of the frictional engagement devices;

FIG. 6A to 6E are schematic enlarged views of the lubrication valve of FIG. 7;

FIG. 7 is a schematic cutaway showing detail of the clutches and clutch shaft;

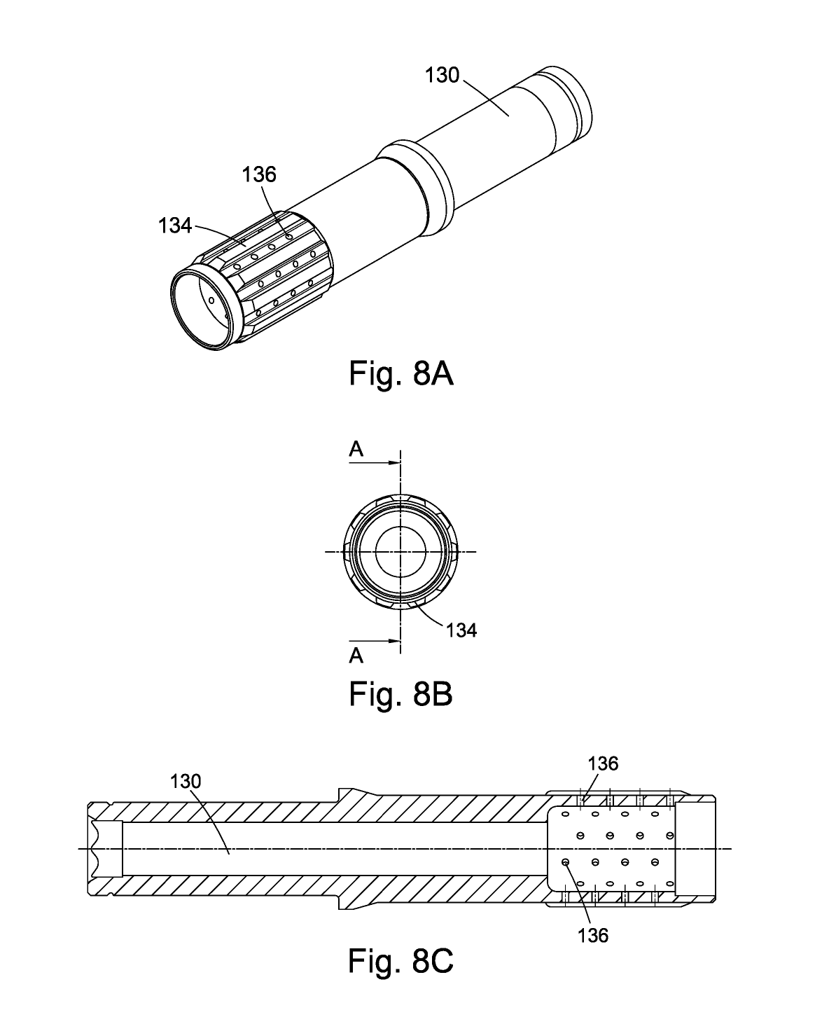

FIGS. 8A and 8B are schematic views of the clutch shaft of FIG. 7; and

FIG. 8C is a section along line A-A of FIG. 8B

The embodiments described in detail below, have in common that a friction engagement device is used to transfer energy and receives a flow of cooling fluid to help remove heat produced by the friction engagement device.

Changes in the flow of cooling fluid to the frictional engagement device are responsive to a cooling control signal. The power transmitted by the frictional engagement device is controlled by a power control signal that changes the magnitude and optionally the direction of power flow through the frictional engagement device.

In some embodiments the cooling control signal may be an electronic signal. The cooling control signal may be generated by an ECU that also generates the power control signal that controls the power through the frictional engagement device. Each signal may act on respective devices such that the flow of cooling oil and the power are controlled in concert as shown in FIG. 1.

Typically, torque of the friction engagement device will be controlled by a clamp load. However, as is known in the art, control of torque at a given operating speed will result in a transmitted power. It is understood, therefore, that the term ‘power control signal’ in this context is used to mean the signal that controls torque and/or power.

In other embodiments the cooling control signal may be a hydraulic, mechanical or hydro-mechanical signal that is generated directly by the act of a driver commanding power to be transferred through the frictional engagement device, as described below in connection with FIG. 2 or 7.

In other embodiments, the cooling fluid (typically oil) supply is common with a control hydraulic supply to the actuator of the frictional engagement device so that as actuation pressure increases, the cooling oil supply becomes pressurised and thus oil flow to the frictional engagement device is correspondingly increased as described in connection with FIG. 3.

In other embodiments a cooling oil supply is directed to the frictional engagement device as a direct result of the movement of the actuator of the frictional engagement device such that as the actuator stroke changes, the flow of cooling oil to the frictional engagement device is suitably changed, as described below in connection with FIG. 4.

The flow of cooling fluid to the frictional engagement device may thus be made to decrease when the magnitude of power through the frictional engagement device is made to decrease, thus reducing drag in the frictional engagement device when energy is not being transferred by the frictional engagement device.

The cooling fluid is preferably a fluid such as oil which has sufficient heat capacity that it is effective at cooling by convection. After the fluid has absorbed heat from the frictional engagement device, it passes through a heat exchanger. When the frictional engagement device is a clutch, the fluid is chosen to provide progressive clutch slip characteristics without judder, such characteristics typically including a progressively increasing friction coefficient as slip increases from the static to the dynamic slipping condition. Preferably the ratio of dynamic to static friction coefficient is greater than 1 but less than 1.2, and more preferably it is less than 1.1.

The frictional engagement device may be a device such as a clutch (see FIGS. 1-4). As described in more detail below, the clutch may be used in series with a variator such as a hydrostatic variator (pump or pump-motor) or a chain, belt or traction drive variator. In such an arrangement, preferably a clutch exists between the energy source/sink and the variator so that both the variator and the storage system may be dis-engaged when energy is not being transferred, for the reduction of losses.

Preferably also there is a clutch between the variator and the storage system in order that the storage system may be dis-engaged from both the energy source/sink and variator, also for the minimisation of losses. Preferably the system comprises both these clutches. In some variators, the presence of both clutches allows the variator to be launched by either the energy source/sink or the storage system prior to any substantive energy being transferred to or from the storage system; this can be an advantage when the variator is a traction drive type, because its rolling surfaces may be desirably caused to entrain fluid before the traction surfaces are made to transmit energy. One or both clutches may also be used in a slipping mode for the transmission of energy to or from the storage system.

The wet clutch may alternatively be used in combination with other similar wet clutches (as described for example, in GB2476676-A), with a set of clutches in parallel with one another, each clutch being in series with a respective gear ratio, the set of clutches and their respective ratios being disposed between the energy source/sink and the storage system for the transmission of energy between them. The rate of energy transfer (that is, power) may then be controlled by modulating the clamp load on the clutches as described earlier and thereby choosing different gear ratios between the energy source/sink and the storage system.

Preferably reacted torque (rather than ratio or rate of change of ratio) of the frictional engagement device is controlled directly, as torque delivery to the energy source/sink, such as a vehicle's wheels is usually the most relevant variable of interest. Delivery of torque typically satisfies a driver's demand for wheel power; the demand being indicated by a driver input such as depression of an accelerator pedal.

Preferably a minimum cooling oil flow is fed to the frictional engagement device at all times whilst it is operating, thus providing lubrication and ensuring good durability of the frictional engagement device. Preferably oil flow rate is increased as power through the frictional engagement device is increased.

Preferably cooling flow following a period of power transfer is maintained at a level above the minimum flow for a pre-determined period in order that the temperature of the frictional engagement device is brought down in anticipation of further power transfer in the future. Extending the cooling period in this way may enable lower maximum cooling flow rates (and hence reduced pump size and cost).

Control of the cooling oil flow may also be at least partially decoupled from the control of the power through the frictional engagement device thus providing accurate independent control over the levels of power flow, cooling flow and drag loss. For example, the cooling control signal and power control signal may be decoupled from one another by using separate control valves (such as solenoid valves) as described below. In another example the pressure fed to an actuator of the frictional engagement device may act as the cooling control signal so that when said pressure is below a threshold level the cooling control signal is off. By increasing the pressure to the actuator, but maintaining it below a pressure that corresponds to a pre-load level of the return mechanism of the clutch, the cooling flow may be controlled in a continuous or step mode, but without torque being transmitted by the clutch. Once the actuation pressure exceeds the pre-load level of the return mechanism of a clutch, the torque transmitted by the clutch is determined by the actuation pressure. Thus the power control signal may be modulated to both control clutch power (or torque) and to tailor the cooling flow, thus reducing the number of required control elements (such as solenoid valves) which tend to form a significant part of the transmission cost.

The power in the frictional engagement device may be adjusted according to the power control signal, this preferably being a pressure generated by a proportional pressure control valve that modulates the hydraulic pressure applied to the frictional engagement device actuation system. Preferably the pressure signal from the proportional solenoid valve, or from another part of the hydraulic system downstream of the pressure control valve, actuates a cooling control device which controls the cooling oil flow rate to the frictional engagement device.

The cooling control device may be an orifice that directly feeds the frictional engagement device, for example, an orifice in the actuation pressure chamber that is directed to the frictional engagement device power transfer surfaces such as the interfaces between clutch friction plates and clutch counter-plates.

Preferably the cooling control device is a pilot operated valve that receives a hydraulic signal from the pressure control valve output and whose flow area is changed as a function of the pressure signal. The hydraulic supply for the cooling device is adapted to run at a higher pressure than that required to cool the frictional engagement device, and therefore the cooling device flow area corresponds to a flow rate of cooling fluid to the frictional engagement device. The hydraulic supply for the cooling device may be a pressure source that is regulated by a relief or pressure regulating valve (see Embodiment 1 or 2 below).

With reference to FIG. 1, a flywheel, is coupled to a vehicle transmission via a plurality of clutches 4. As described for example in GB2476676, the clutch, which may be a single clutch or a plurality of clutches, is typically a wet clutch so that it is readily able to operate in a slipping mode for an extended duration. The clutch may be a wet multi-plate clutch, and the torque transmitted whilst it is slipping may be controlled by applying a clamp force to the clutch pack. Preferably the clutch is cooled with oil and is a wet multi-plate clutch.

Preferably the oil is fed to the centre of the clutch. This may be achieved by channelling oil through a shaft 6 that is coaxial with the clutch; the shaft entering the casing via a thrust bearing 7 that accommodates the relative speed between casing and shaft. Oil is then fed via radial passages 11 to the centre of the clutches and which is then distributed outwardly from the centre by virtue of the clutches' rotating action in use. Afterwards, oil is returned to a sump 9 which feeds the pump 10. Preferably the oil first passes through a heat exchanger (not shown) or may be cooled in the sump, to remove heat extracted from the clutches, before it is re-circulated by the pump 10. The cooling flow may be supplied by a separate supply/pump from the actuation supply for the clutch (for example, as shown in FIGS. 1 and 2).

Preferably the clutch is actuated by a hydraulic actuator comprising a piston 8 that bears against the plates, clamping one or more friction plates 4 against one or more counter-plates 5 which are typically made from steel. The piston may be actuated by hydraulic pressure on one side 10 and a return mechanism on the opposite side. The return mechanism may comprise biasing means such as a mechanical spring, or a regulated hydraulic pressure. The arrangement is pressurized by a pump 10 which is connected to a control valve 12 and, via a pressure regulating arrangement 14, to a second control valve 16. The valve 14 is shown as a simple way to illustrate a substantially constant high pressure supply to the clutch actuation valve 12. It is not necessarily arranged to control the cooling supply pressure or flow, which will generally requite a different pressure to that of the actuator.

Instead, the cooling supply pressure is nominally regulated (held constant) by relief valve 17 and thus since the cooling supply pressure is substantially constant, then the opening of valve 16 will control the flow rate to the clutch. The two control valves 12 and 16 are directly actuated by an ECU 18.

The power (or torque) transmitted by the frictional engagement device formed by the clutches 4 and counter-plates 5, may be adjusted according to the power control signal, this preferably being a pressure generated by a proportional pressure control valve that modulates the hydraulic pressure applied to the frictional engagement device actuation system. Thus the control valve 12 is used to modulate the actuating pressure driving the piston 8. Accordingly this controls the pressure applied to the clutches 4. This in turn will generally relate to the torque transmitted through the frictional engagement device.

The control valve 16 controls a flow of cooling oil via the passage 6 into the clutches. Thus the ECU may independently control the clutch actuation pressure and the cooling flow. By programming the ECU appropriately, the functional requirements discussed above may readily be achieved.

FIG. 2 shows a simpler arrangement. In this embodiment, the power control signal is fed directly to the valve 12 which then has a pilot feed directed to a valve 16′ which controls the feed of cooling fluid to the clutch. Cooling flow pressure is still regulated by a valve 17. In this way, an increase in actuation pressure may automatically increase the flow of cooling fluid to the cooling control valve 16′ and clutch 4. The relationship between cooling flow and actuation pressure may thus be built into the system operating parameters at manufacture. As a further variation, the control valve need not be infinitely variable on the cooling control side and may produce an on/off type control once the actuation pressure is above a pre-determined threshold.

Alternatively, the valve 16′ may be caused to open and supply cooling fluid at an actuation pressure that is less than that required to overcome a bias of the return mechanism of the clutch. The cooling flow may therefore be varied at a low level without the clutch transmitting torque, for instance to supply a low level of lubrication to the clutch. Increasing the actuation pressure such that the clutch overcomes the bias of its return mechanism causes cooling to be further increased as transmitted torque increases. The slip event of the clutch endures while it is transmitting torque and slipping, thus generating heat, but it may end when the actuation pressure is subsequently lowered such that the clutch torque reaches zero. At this point cooling flow may be controlled by varying the actuation pressure between the level required to open valve 16′ and the level required to raise torque in the clutch. Thus the clutch may be cooled following a slip event with the required amount of flow and for the required time period, such that the clutch is returned to the required temperature before the next slip event occurs.

With reference to FIG. 3, a yet further simplified arrangement dispenses entirely with the cooling control valve. In this arrangement, a feed is taken directly from the hydraulic feed to the piston 8 and fed into the cooling passage 6. This is a particularly simple and robust implementation and typically a flow restriction 18 is used (possibly in conjunction with a flow restriction 20) to allow adequate actuation pressure for the piston 8 without excessive cooling flow via the passage 6. This embodiment may include an actuator return mechanism in order to allow control of cooling flow independently of clutch torque, as described in connection with FIG. 2.

FIG. 4 shows a further variant in which the piston 8 has an internal passage 22 which communicates with an outlet port of control valve 12. The passage 22 allows cooling fluid to flow from the outer perimeter of the piston 8 to its internal surface where it is mounted on the shaft. A flow restriction 24 controls cooling flow relative to the actuator pressure applied to the piston 8. As the piston moves to the right of the Figure away from the position shown in FIG. 4, the passage 22 comes into alignment with a port on the cylinder wall and fluid is allowed to pass into the passage 22 and then through the passage 22 into a bore 26 inside the shaft. The fluid is then distributed to the clutches 4 via the radial passages 11 which communicate with the axially extending bore 26. In this way, the stroke of the piston which is used to actuate the clutches, also causes cooling of the clutches. By varying the shaping of the inlet to the port 22 and its position in the bore in which piston 8 runs and the shaping of the inlet to the bore 26 in the shaft, the degree of cooling flow may be controlled in order to achieve a desired cooling profile relative to clutch actuation stroke. Alternatively, the cooling supply to the clutch piston may be separate from the actuation pressure (as shown in FIGS. 1 and 2) and then the cooling flow need not be dependent upon the actuation pressure, but instead be dependent upon the piston stroke (and port and passage profiles), and therefore the state of engagement of the clutch. This embodiment may include an actuator return mechanism in order to allow control of cooling flow independently of clutch torque, as described in connection with FIG. 2.

In these embodiments in which power transmission through the clutch is controlled by modulating hydraulic pressure applied to the clutch actuator, the high rotating speed of the device can cause ‘centripetal’ hydraulic pressures to be generated in the actuation chamber which cause the clutch to self-actuate as the speed increases. This problem may be solved by suitably increasing the bias force of the clutch return mechanism. Preferably, however, the hydraulic actuator does not rotate, and the actuator bears on the clutch plates through a thrust bearing 7 that accommodates relative rotation of the actuator and clutch plates. Thus the clutch clamp force may be independent of speed and control of power is improved. A second thrust bearing may bear the clamp load from a second clutch member as it rotates relative to the transmission casing.

With reference to FIG. 5, a clutch 100 that may be one of a set of clutches of the energy recovery transmission, is selectively coupled via coupling 100a to an energy source/sink at an end A (for example the driveline of a vehicle), and also selectively coupled via a second coupling 100b to a flywheel storage system B, this preferably being a high speed flywheel. When the ECU issues a signal to energise coupling 100a, the input to the clutch 100 of the energy recovery transmission becomes rotatable by end A so that rotation of end A also causes rotation of the cooling pump 10. Thus the signal to energise coupling 100a also acts as a cooling control signal as it causes the cooling pump 10 to become coupled to end A. Thus when coupling 100a is engaged and end A rotates, pump 10 delivers cooling flow to the central shaft feed of clutch 100 as described above, which cools the clutch 100 (or set of clutches) in a similar manner to that described in FIG. 7. Alternatively end A may be the flywheel end and B the energy source/sink end so that when the energy recovery transmission is coupled to the flywheel, the pump 10 provides cooling flow to the clutch 100. This embodiment may optionally be combined with any of the other embodiments from FIGS. 1 to 4. For example, the output of cooling pump 10 may be the feed to pilot valve 16′ in FIG. 2, or it may be an independent cooling feed to cooling control solenoid valve 16 in FIG. 1.

Any one of, several, or each clutch of the energy recovery transmission may have its cooling flow controlled according to any one of the embodiments 1 to 5. In particular, one or several clutches in the transmission which includes embodiment 5 may have its or their cooling flow controlled using any one of embodiments 1 to 4. Alternatively, each or several clutches in embodiment 5 may simultaneously receive flow from the cooling pump 10 whenever the pump 10 is rotating, without the cooling control means of embodiments 1 to 4.

With reference to FIGS. 6 and 7, a detailed implementation of the arrangement of FIG. 2 will now be described.

A clutch pack 100 having a plurality of wet clutches, is actuable by a hydraulic actuator 102. The actuator 102 is fed from a hydraulic manifold 104 via a clutch feed line 106. Hydraulic pressure in the feed line 106 is also passed, via a lubrication control line 108, to a lubrication control valve 110.

With particular reference to FIGS. 6A to 6E, the valve 110 has a shuttle 112 which is movable axially in a valve body 114. The valve body has lubrication outlet feeds 116 which communicate with an oil feed to the clutch pack 100 for cooling and lubrication purposes, and which is described in more detail below. Hydraulic pressure from the clutch actuation circuit 108 enters the valve body 114 via a hydraulic feed port 118 which has the effect of moving the shuttle 112 rightwards as drawn in FIG. 6A.

A lubrication/cooling oil feed enters the shuttle 112 via a lubrication port 120 which communicates with shuttle outlet ports 122A and 122B. It will be noted that outlet port 1228 is narrower than port 122A. As drawn in FIG. 6A, when the shuttle 112 is towards the left, a constant trickle of lubrication fluid is allowed through the narrow outlet 1228 to provide low-level, background cooling and lubrication of the clutch pack 100 when the clutch is not engaged. The shuttle 112 is optionally biased in the left hand position for example, with a spring such as a coil spring. Alternatively the shuttle 112 may be biased to the left by the pressure in the lubrication circuit that bears on the right hand side of shuttle 112 in this position. When the clutch is actuated and engaged, the shuttle 112 moves to the right against the biasing force because of the increased pressure in the feed line 108, and then allows lubrication fluid to pass through the larger outlet 122A into the lubrication outlet feeds 116 which thus greatly increases the flow of lubrication and cooling oil to the clutch pack 100. In this way, cooling and lubrication flow is automatically increased when the clutch pack 100 is actuated. Conversely, when the clutch is no longer actuated, cooling flow to the clutch is decreased and thus drag in the clutch is reduced. Cooling flow may optionally be controlled at a level above the background lubrication level by adjustment of the clutch actuation pressure at a level below that required to engage the clutch.

FIGS. 6C-6E show the valve disassembled with an end plate 124 holding the shuttle 112 in the valve body 114 and acting as an endstop for the shuttle 112. They also show the shuttle seals for sealing it inside the body, e.g. by O-rings 126. This seal keeps the clutch actuation fluid separate from the lubrication/cooling fluid, although preferably, these may be the same fluid

With reference to FIG. 7, the lubrication/cooling oil from the valve 110 passes through a flow restriction 128 into a hollow shaft 130 on which the clutch plates 132 are mounted via splines 134 (see FIGS. 8A and 8B). The flow restriction 128 preferably sprays the cooling oil onto the inner surface of the shaft 130. The shaft 130 has holes 136 distributed circumferentially and between the splines 134 which deliver oil from the hollow inner of the shaft to the outside and directly to the clutch centres. Oil then flows radially out across the clutches as they rotate, and eventually drains through optional holes 133 in the outer periphery of the clutch drum, and back into a tank for cooling and re-circulation through the lubrication valve 110.

In the embodiments described above, the input from energy source/sink, to the friction engagement device may be arranged to rotate faster than the speed of the energy source/sink, e.g. using a step-up gear.

1. An energy recovery transmission having a friction engagement device such as a clutch, further comprising:
a cooling fluid input arranged to supply cooling fluid to the friction engagement device, the transmission further comprising a cooling flow controller that controls the flow to the friction engagement device, wherein the energy recovery transmission further comprises a high speed flywheel.

2. An energy recovery transmission as claimed in claim 1, wherein the cooling flow controller is arranged to generally increase cooling flow with the state of engagement of the friction engagement device such as increased flow with increased transmitted torque and/or speed differential across the device and/or dissipated power of the friction engagement device during a slip event.

3. An energy recovery transmission as claimed in claim 1, wherein the cooling flow controller is operable to produce different cooling flow rates over a continuous range between a high flow and a relatively lower flow.

4. An energy recovery transmission as claimed in claim 1, wherein the cooling flow controller is operable to produce two discrete cooling flow rates at a high flow and a relatively lower flow.

5. An energy recovery transmission as claimed in claim 1, wherein the cooling flow controller is arranged to cause a non-zero flow of cooling fluid including when substantially zero torque is transmitted through the friction engagement device, substantially zero differential speed occurs across the friction engagement device during a slip event or substantially zero power is dissipated in the friction engagement device.

6. An energy recovery transmission as claimed in claim 1, wherein the cooling flow controller is arranged to cause cooling flow to cease when the friction engagement device is disengaged.

7. An energy recovery transmission as claimed in claim 1, wherein the cooling flow controller is arranged to maintain the flow of cooling fluid at a predetermined level for a predetermined time period after a slip event of the friction engagement device.

8. An energy recovery transmission as claimed in claim 1, wherein the cooling flow controller is arranged to maintain the flow of cooling fluid at a non-zero level for a time period that is a function of the energy dissipated during an immediately prior slip event of the friction engagement device.

9. An energy recovery transmission as claimed in claim 1, further comprising an electronic programmable transmission controller operable to act directly on the cooling flow controller and also to directly control the actuation of the friction engagement device, the transmission controller being arranged to generate control signals which generally increase cooling flow with increased torque transmission and/or slip speed and/or dissipated power of the friction engagement device.

10. An energy recovery transmission as claimed in claim 1, wherein the friction engagement device is actuated by a pressure control valve and the cooling flow controller is a pilot operated valve that receives a hydraulic signal from the pressure control valve output and whose flow area is changed as a function of the pressure signal.

11. An energy recovery transmission as claimed in claim 1, wherein the friction engagement device is actuated by a pressure control valve and the cooling flow is derived directly from the friction engagement device actuator pressure.

12. An energy recovery transmission as claimed in claim 1, wherein the friction engagement device is actuated by a piston in a bore and the bore comprises a port which is aligned with a cooling flow port in the piston at a predetermined position in the piston stroke, such that in this position, cooling fluid is communicated through the cooling flow port in the piston to be directed to cool the friction engagement device, whereby cooling is controlled by the actuator piston stroke position.

13. An energy recovery transmission as claimed in claim 1, further comprising a pump for providing cooling fluid to the cooling input, and a drive for the friction engagement device, wherein the pump drive is selectively coupled to the friction engagement device drive.

14. An energy recovery transmission as claimed in claim 13, wherein the friction engagement device drive is either a flywheel drive or a drive to a vehicle.

15. An energy storage and recovery system as claimed in claim 1, further comprising an energy source/sink, wherein at least one rotational element of the friction engagement device is arranged to rotate faster than the speed of the energy source/sink.

16. (canceled)

17. An energy recovery transmission as claimed in claim 1, wherein the high speed flywheel is arranged to rotate at over 15,000 rpm.

18. An energy recovery transmission as claimed in claim 1, wherein the energy recovery system comprises a plurality of friction engagement devices.

19. An energy recovery transmission as claimed in claim 18, wherein the cooling flow controller is arranged to control the flow to the friction engagement device dependent on the state of the friction engagement device which is transmitting the most torque or dissipating the most power.

20. An energy recovery transmission as claimed in claim 17, wherein one cooling flow controller is arranged to provide flow to at least two of the plurality of clutches simultaneously.

21. A method of modulating cooling in a friction engagement device for an energy recovery transmission, for transmitting energy between an energy storage device and an energy source/sink comprising the steps of:
providing a flow of fluid past the frictional engagement device such that heat is transferred from the frictional engagement device to the fluid,
providing means for removing heat from the cooling fluid, and
modulating the flow of cooling fluid dependent on the state of engagement of the friction engagement device such as increased flow with increased transmitted torque and/or speed differential across the device during a slip event and/or dissipated power of the friction engagement device during a slip event.

22. A method of modulating cooling in a frictional engagement device for an energy recovery transmission according to claim 21, further comprising the steps of:
providing an actuator to engage, disengage and/or allow slipping operation of the frictional engagement device, and
modulating the flow of cooling fluid dependent on the clamp force applied to the frictional engagement device.

23. A method of modulating cooling in a frictional engagement device for an energy recovery transmission according to claim 22, wherein the actuator is a hydro-mechanical actuator.

24. A method of modulating cooling in a friction engagement device for an energy recovery transmission according to claim 21, further comprising the steps of:
determining the slip across the frictional engagement device, and
modulating the flow of cooling fluid dependent on the slip across the frictional engagement device.

25. A method of modulating cooling in a friction engagement device for an energy recovery transmission according to claim 24, further comprising the step of modulating the flow of cooling fluid dependent on the power dissipated in the frictional engagement device.

26. A method of modulating cooling in a friction engagement device for an energy recovery transmission for transmitting energy between an energy storage device and an energy source/sink, comprising the steps of:
providing a flow of fluid past the frictional engagement device such that heat is transferred from the frictional engagement device to the fluid,
providing means for removing heat from the cooling fluid,
determining the energy dissipated during a slip event of the frictional engagement device,
determining a target cooling flow profile and cooling time from the energy dissipated, and
modulating the flow of cooling fluid according to said target cooling flow profile over said period of time.

27. (canceled)
